(19) United States
(12) Patent Application Publication
(10) Pub. No.: US 2016/0180028 A1
(43) Pub. Date: Jun. 23, 2016

(54) INFORMATION RETRIEVAL PROCESSING DEVICE AND METHOD

(71) Applicant: FUJITSU LIMITED, Kawasaki-shi (JP)

(72) Inventor: Tatsuo HAYAKAWA, Toyoake (JP)

(73) Assignee: FUJITSU LIMITED, Kawasaki-shi (JP)

(21) Appl. No.: 15/054,283

(22) Filed: Feb. 26, 2016

Related U.S. Application Data
(63) Continuation of application No. PCT/JP2013/073584, filed on Sep. 2, 2013.

(51) Int. Cl. G06F 19/00; G06F 17/30

(52) U.S. Cl. CPC G06F 19/322; G06F 17/30321; G06F 17/30542

(57) ABSTRACT

A recording medium having stored therein a program causes a computer to execute a process. The process includes determining keyword information that corresponds to description information given in an electronic health record read from an electronic health record storage in accordance with a master storage that stores keyword information of a target and code information that identifies the target in association with each other, reading the code information that corresponds to the determined keyword information from the master storage, and generating index information that corresponds to the read electronic health record by associating the identification information that corresponds to the read electronic health record with each of the determined keyword information and the read code information.

### CROSS-REFERENCE TO RELATED APPLICATION

This application is a continuation application of International Application PCT/JP2013/073584 filed on Sep. 2, 2013 and designated the U.S., the entire contents of which are incorporated herein by reference.

### FIELD

The embodiments discussed herein are related to an information retrieval processing device and a method.

### BACKGROUND

With the widespread use of electronic health records, the following conventional technology is known in which a doctor or the like retrieves similar cases or the like, for example, in a case where a pharmaceutical product is administered, from information described in past electronic health records by using, for example, the name of a pharmaceutical product as a keyword (for example, Patent Document 1). When a computer receives, from a user, an activation instruction to activate an input tool that assists an operation of inputting medical examination information into an input area, the computer obtains a prescribed keyword from a storage in which the prescribed keyword has been stored. When the obtained keyword is included in the medical examination information of a medical examinee that has been input into the input area, the computer transmits the keyword included in the medical examination information to the input tool. The storage has stored a prescribed keyword for each of the input tools, and the computer obtains, from the storage, a keyword that corresponds to an input tool identified by the activation instruction.

Conventionally, the extraction of an electronic health record that matches a retrieval condition desired by a user is requested.

Patent Document 1: Japanese Laid-open Patent Publication No. 2010-286922

Patent Document 2: Japanese Laid-open Patent Publication No. 9-171528

### SUMMARY

According to an aspect of the embodiments, a non-transitory computer-readable recording medium having stored therein a program causes a computer to execute a process. The process includes reading an electronic health record from an electronic health record storage that stores identification information that identifies the electronic health record and description information given in the electronic health record in association with each other, determining keyword information that corresponds to the description information given in the read electronic health record in accordance with a master storage that stores keyword information of a target and code information that identifies the target in association with each other, reading the code information that corresponds to the determined keyword information from the master storage, and generating index information that corresponds to the read electronic health record by associating the identification information that corresponds to the read electronic health record with each of the determined keyword information and the read code information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an information retrieval processing device according to the embodiments.

FIG. 2 illustrates an example of a data configuration of a user master dictionary.

FIG. 3 illustrates an example of a data configuration of master information.

FIG. 4 illustrates an example of a data configuration of a user morpheme dictionary.

FIGS. 5A-5C are a diagram explaining an example of a transition of data according to the embodiments.

FIG. 6 illustrates a data configuration of exemplary index information.

FIG. 7 is a flowchart illustrating an example of a process of generating a user master dictionary and a user morpheme dictionary.

FIG. 8 is a flowchart illustrating an example of a process of generating index information.

FIG. 9 is a flowchart illustrating an example of a retrieval process.

FIG. 10 illustrates an example of a hardware configuration of an information retrieval processing device.

### DESCRIPTION OF EMBODIMENTS

In order to retrieve description information of electronic health records by using a keyword, a process of performing a full-text search on the electronic health records is needed. As an example, when there are 50,000,000 electronic health records, it takes about one hour to perform a full-text search. Accordingly, retrieval can be performed efficiently by preparing in advance an index table of keywords that appear in the electronic health records.

In the index table, inverted index information is stored, for example. The inverted index information is generated in such a way that a keyword extracted from an electronic health record is associated with a record number of the electronic health record describing the keyword.

Assume, as an example, that retrieval has been performed so as to discover that a keyword “itch” is given in electronic health records respectively having record numbers 001, 003, and 004. In this case, the keyword “itch” is stored in the index table in association with the record numbers 001, 003, and 004.

When an operator retrieves the keyword “itch”, the operator references the index table so as to read the record numbers 001, 003, and 004 that correspond to the keyword “itch”, and retrieval is completed. Accordingly, a retrieval time can be reduced by preparing inverted index information.

In retrieval of electronic health records, an operator may desire to perform retrieval using code information. As an example, an operator may desire to retrieve electronic health records that correspond to a meaningful code (a pharmaceutical product code) without performing retrieval using the name of a pharmaceutical product.

However, the code information is not included in description information of the electronic health record in some cases. As described above, inverted index information that corresponds to an electronic health record is generated on the basis of a keyword extracted from the electronic health record. Therefore, when the code information is not included in the description information of the electronic health record, there is a problem wherein the electronic health records fail to be retrieved by using the code information.

Embodiments are described below in detail with reference to the drawings.

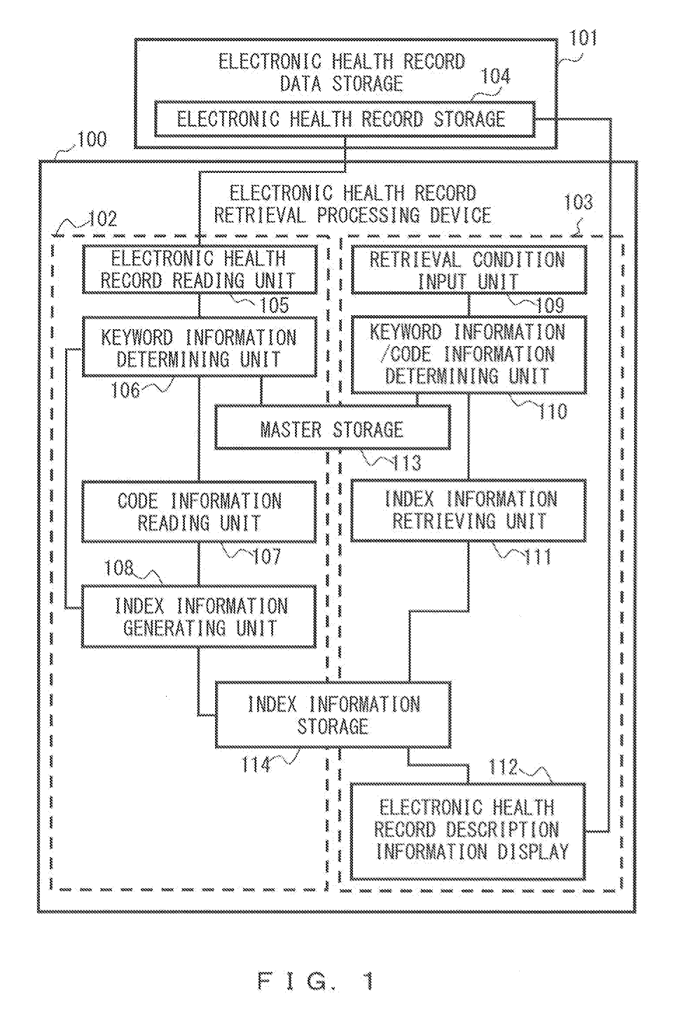

FIG. 1 is a block diagram illustrating an information retrieval processing device according to embodiments (hereinafter referred to as “the embodiments”).

An information retrieval processing device according to the embodiments is configured of an electronic health record retrieval processing device 100 and an electronic health record data storage 101. The electronic health record data storage 101 is one or more computers that each include an electronic health record storage 104 that stores electronic health records as a database. The electronic health record retrieval processing device 100 is one or more computers that each include an index information generating function unit 102, a retrieval processing function unit 103, a master storage 113, and an index information storage 114. The index information generating function unit 102 includes an electronic health record reading unit 105, a keyword information determining unit 106, a code information reading unit 107, and an index information generating unit 108. The retrieval processing function unit 103 includes a retrieval condition input unit 109, a keyword information/code information determining unit 110, an index information retrieving unit 111, and an electronic health record description information display 112.

In the electronic health record data storage 101, the electronic health record storage 104 is a database that stores, for each electronic health record, identification information for identifying the electronic health record, such as a record number, and description information of the electronic health record in association with each other.

The master storage 113 in the electronic health record retrieval processing device 100 stores keyword information of a target and code information for identifying the target in association with each other, for example, as a user master dictionary. Examples of the target include a pharmaceutical product. Examples of the keyword information of the target include the name of a pharmaceutical product. Examples of the code information for identifying the target include code information for identifying a pharmaceutical product. Hereinafter, the keyword information and the code information in the user master dictionary are referred to as “master keyword information” and “master code information”, respectively.

In the index information generating function unit 102 in the electronic health record retrieval processing device 100, the electronic health record reading unit 105 reads an electronic health record from the electronic health record storage 104.

The keyword information determining unit 106 determines keyword information that corresponds to description information given in the electronic health record read by the electronic health record reading unit 105 on the basis of, for example, the user master dictionary stored in the master storage 113. Hereinafter, the keyword information determined as described above is referred to as “keyword information for an index”.

The code information reading unit 107 reads code information that corresponds to the keyword information determined above, for example, from the user master dictionary stored in the master storage 113. Hereinafter, the code information read as described above is referred to as “code information for an index”.

The index information generating unit 108 associates identification information that corresponds to the electronic health record read by the electronic health record reading unit 105 with the keyword information for an index above and the code information for an index above. By doing this, the index information generating unit 108 generates index information that corresponds to the electronic health record, and stores the index information in the index information storage 114.

In the retrieval processing function unit 103 of the electronic health record retrieval processing device 100, the retrieval condition input unit 109 inputs a retrieval condition specified via a terminal device or the like operated by a user of electronic health records.

The keyword information/code information determining unit 110 determines keyword information for retrieval and code information for retrieval that correspond to the retrieval condition input by the retrieval condition input unit 109, according to, for example, the user master dictionary stored in the master storage 113.

The index information retrieving unit 111 retrieves keyword information for an index or code information for an index that corresponds to the above keyword information for retrieval or the above code information for retrieval in the index information stored in the index information storage 114. Then, the index information retrieving unit 111 extracts identification information that corresponds to a result of the retrieval above.

The electronic health record description information display 112 reads description information of an electronic health record that corresponds to the identification information extracted by the index information retrieving unit 111, from the electronic health record storage 104 in the electronic health record data storage 101, and displays the description information on the terminal device or the like operated by the user of the electronic health records.

An action of an information retrieval processing device according to the embodiments having the configuration above is described below in detail.

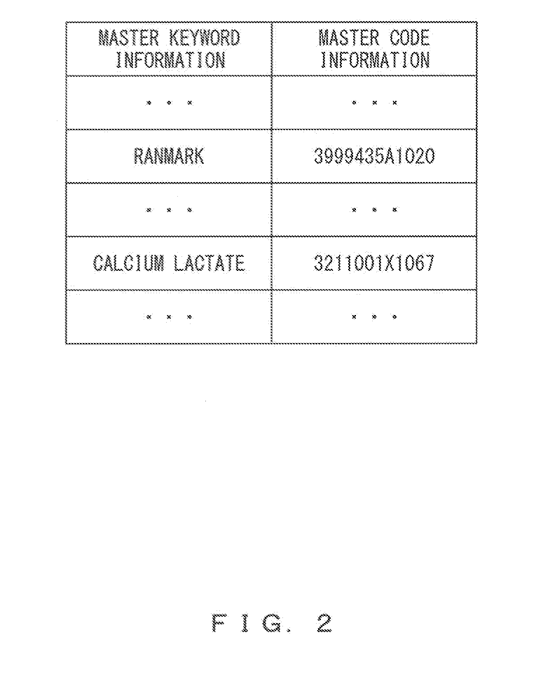

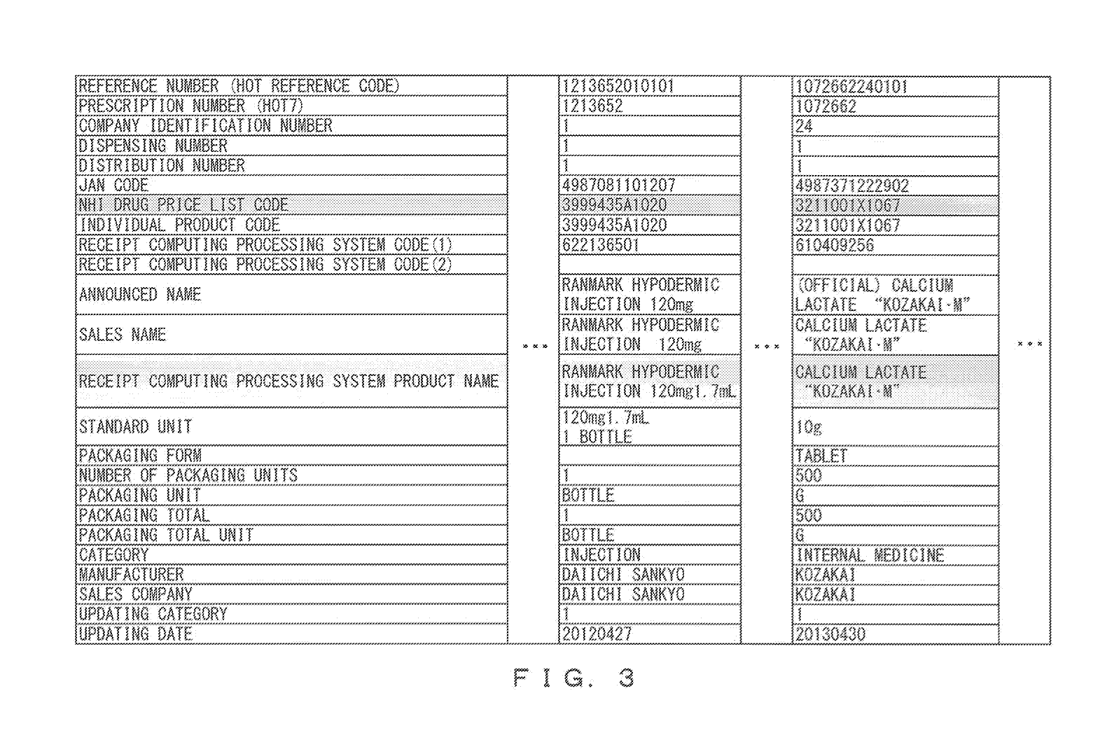

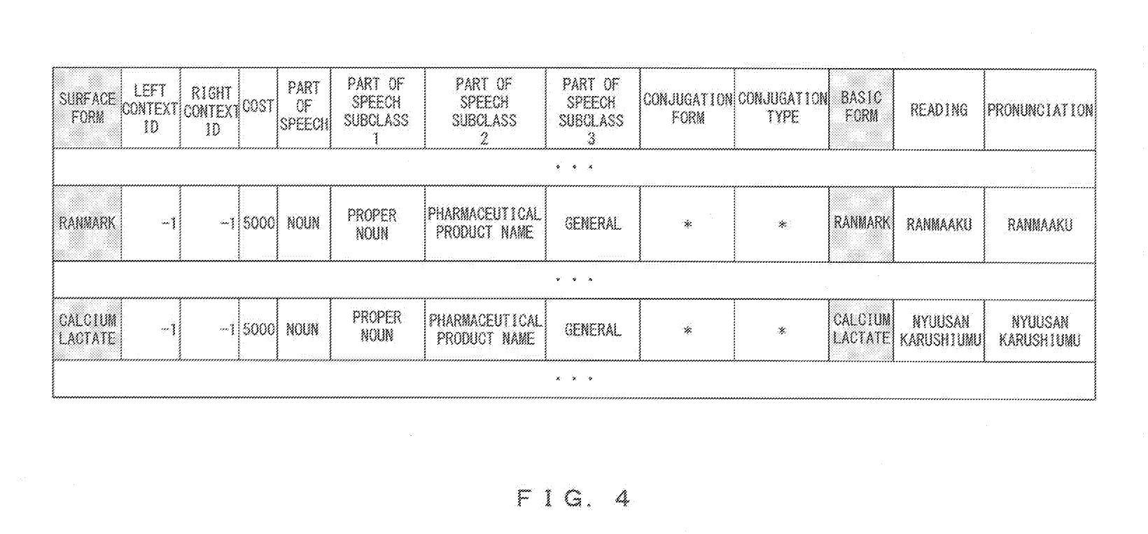

FIG. 2, FIG. 3, and FIG. 4 respectively illustrate examples of data configurations of a user master dictionary, master information, and a user morpheme dictionary used in the embodiments.

As illustrated in FIG. 2, the user master dictionary is a table storing master keyword information and master code information of a target in association with each other, and is stored in the master storage 113 in the electronic health record retrieval processing device 100 illustrated in FIG. 1. Examples of the master keyword information include the name of a pharmaceutical product. Examples of the master code information include code information for identifying a pharmaceutical product.

In the embodiments, in the generation of index information, the keyword information determining unit 106 illustrated in FIG. 1 first determines keyword information for an index that corresponds to description information given in an electronic health record, according to the user master dictionary illustrated in FIG. 2.

For the first method for determining the keyword information for an index according to the user master dictionary, the following method can be employed. Keyword information is first extracted from description information given in a read electronic health record. In this case, as an example, morphological analysis in which a sentence of the description information given in the read electronic health record is divided into a string of morphemes is performed, and from among obtained morphemes, a morpheme that is determined to be a prescribed part of speech (for example, any one of a noun, a verb, an adjective, and an adjective verb) is extracted as keyword information. A fuzzy search is performed on the master keyword information in the user master dictionary by using the keyword information. The “fuzzy search” refers to retrieval of master keyword information that includes a character string of keyword information as all or part of the master keyword information, and retrieval in which a two-byte character is considered to be the same as a one-byte character, an uppercase letter is considered to be the same as a lowercase letter, katakana is considered to be the same as hiragana, or a long sound is considered to be the same as a short sound. When the fuzzy search is successful, the master keyword information retrieved in the user master dictionary is determined to be keyword information for an index.

As an example, “RANMARK” (a generic name for a pharmaceutical product) is a noun. When morphological analysis is performed on text documents of pieces of description information of electronic health records including the pharmaceutical product name “RANMARK”, the pharmaceutical product name “RANMARK” may be divided into two morphemes, “RAN” and “MARK”. When index information is generated by associating pieces of identification information of electronic health records in which either of the two morphemes “RAN” and “MARK” appears with a corresponding one of the two morphemes “RAN” and “MARK”, it is likely that electronic health records that correspond to the retrieval condition “RANMARK” will not be retrieved. Accordingly, in the embodiments, a user master dictionary associating, for example, the master keyword information “RANMARK”, which is the name of a pharmaceutical product, with the corresponding master code information “3999435A1020” has been prepared in advance, as described above. By performing a fuzzy search on the user master dictionary by using the two respective morphemes “RAN” and “MARK”, the master keyword information “RANMARK” that corresponds to the two respective morphemes “RAN” and “MARK” is extracted, and the master keyword information “RANMARK” is determined to be keyword information for an index. By doing this, the correct keyword information for an index “RANMARK” can be determined for the text documents of the pieces of description information of the electronic health records including the pharmaceutical product name “RANMARK”.

The user master dictionary associating the master keyword information with the master code information, as illustrated in FIG. 2, is obtained from master information such as the Standard Master for Pharmaceutical Products (medical HOT code master) developed by MEDIS-DC (Medical Information System Development Center). FIG. 3 illustrates an example of a data configuration of the master information “Standard Master for Pharmaceutical Products”. As an example, in a record configuration of this master information, a value of the item “receipt computing processing system product name” and a value of the item “NHI (National Health Insurance) drug price list code” are respectively extracted as master keyword information and master code information so as to generate the user master dictionary.

In this case, the value “3999435A1020” of the item “NHI drug price list code” corresponds to the value “RANMARK Hypodermic Injection 120 mg 1.7 mL” of the item “receipt computing processing system product name”. Stated another way, a formal pharmaceutical product name for RANMARK is “RANMARK Hypodermic Injection 120 mg 1.7 mL”, but “RANMARK Hypodermic Injection 120 mg 1.7 mL” is not usually input in a health record.

Accordingly, as an example, when a value of the item “receipt computing processing system product name” of the Standard Master for Pharmaceutical Products is used for the master keyword information, the value “RANMARK”, which is frequently input as description information of an electronic health record, may be used, as illustrated in FIG. 2.

Note that a user master dictionary that includes “RANMARK Hypodermic Injection” and “RANMARK Hypodermic Injection 120 mg 1.7 mL”, in addition to “RANMARK”, as a pattern of the master keyword information in the user master dictionary may be generated.

Similarly, the value “3211001X1067” of the item “NHI drug price list code” corresponds to the value “Calcium Lactate ‘KOZAKAI•M’” of the item “receipt computing processing system product name”, as illustrated in FIG. 3. Stated another way, a formal pharmaceutical product name for “Calcium Lactate” is “Calcium Lactate ‘KOZAKAI•M’”, but “Calcium Lactate ‘KOZAKAI•M’” is not usually input in a health record.

Accordingly, as an example, when a value of the item “receipt computing processing system product name” of the Standard Master for Pharmaceutical Products is used for the master keyword information, the value “Calcium Lactate”, which is frequently input as description information of an electronic health record, may be used, as illustrated in FIG. 2.

Note that a user master dictionary that includes “Calcium Lactate ‘KOZAKAI•M’”, in addition to “Calcium Lactate”, as a pattern of the master keyword information in the user master dictionary may be generated.

Further, index information that includes the respective pieces of master keyword information extracted above from the user master dictionary as keyword information for an index may be generated.

In the first method above, index information with a high accuracy can be generated for a variety of retrieval conditions that correspond to “RANMARK” or “Calcium Lactate” given as description information of an electronic health record.

The following method can be employed as the second method for determining keyword information for an index according to the user master dictionary. In morphological analysis on a sentence of description information of an electronic health record, respective pieces of master keyword information, such as “RANMARK” or “Calcium Lactate” illustrated in FIG. 2, are registered in a user dictionary of morphological analysis (hereinafter referred to as a “user morpheme dictionary”). Then, morphological analysis in which the sentence of the description information given in the read electronic health record is divided into a string of morphemes is performed, and from among obtained morphemes, a morpheme that has been determined to be a prescribed part of speech is determined to be keyword information for an index.

In the second method above, respective pieces of master keyword information in the user master dictionary can be divided into morphemes, and index information with a high accuracy can be generated.

FIG. 4 illustrates an example of a data configuration of a user morpheme dictionary. Pieces of record data in the user morpheme dictionary are generated that respectively include the pieces of master keyword information “RANMARK” and “Calcium Lactate” of the user master dictionary illustrated in FIG. 2 as a surface-form item and a basic-form item.

Then, in the embodiments, when index information is generated, the code information reading unit 107 illustrated in FIG. 1 reads, from the user master dictionary illustrated in FIG. 2, master code information that corresponds to the keyword information for an index determined by the keyword information determining unit 106 illustrated in FIG. 1, as described above, and determines the master code information to be code information for an index.

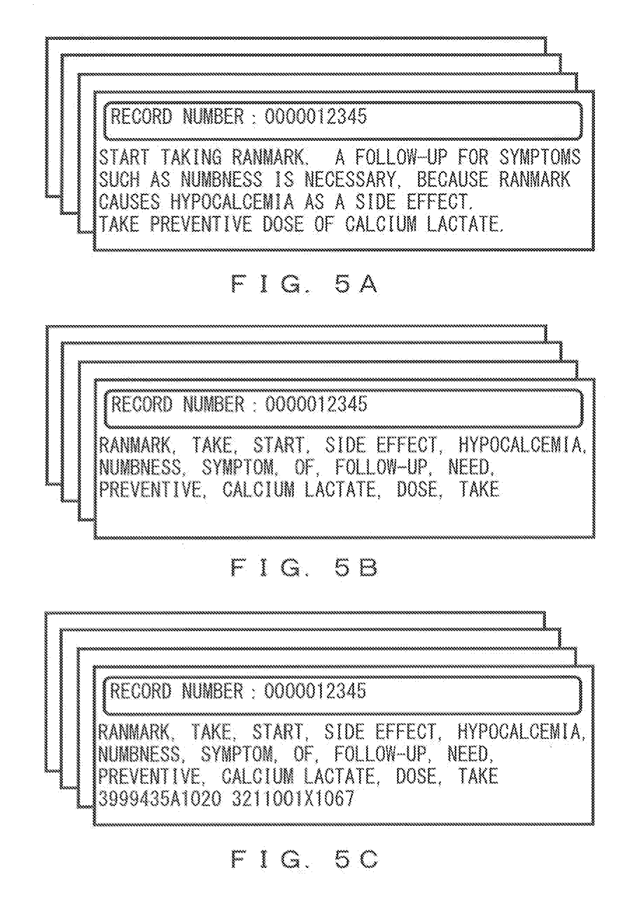

FIGS. 5A-5C are a diagram explaining an example of a transition of data according to the embodiments.

Assume that “START TAKING RANMARK. A FOLLOW-UP FOR SYMPTOMS SUCH AS NUMBNESS IS NECESSARY, BECAUSE RANMARK CAUSES HYPOCALCEMIA AS A SIDE EFFECT. TAKE PREVENTIVE DOSE OF CALCIUM LACTATE.” has been registered as description information of an electronic health record, as illustrated in FIG. 5A.

As a result of a process of determining keyword information for an index based on the morphological analysis above, keyword information for an index such as “RANMARK, TAKE, START, SIDE EFFECT, HYPOCALCEMIA, NUMBNESS, SYMPTOM, OF, FOLLOW-UP, NEED, PREVENTIVE, CALCIUM LACTATE, DOSE, TAKE” is determined, as illustrated in FIG. 5B.

Further, as a result of the process above of determining code information for an index, code information for an index such as “3999435A1020, 3211001X1067” is determined, in addition to the above keyword information of an index, as illustrated in FIG. 5C.

In the embodiments, the index information generating unit 108 illustrated in FIG. 1 associates identification information that corresponds to a read electronic health record with each piece of the above keyword information for an index and the above code information for an index so as to generate index information.

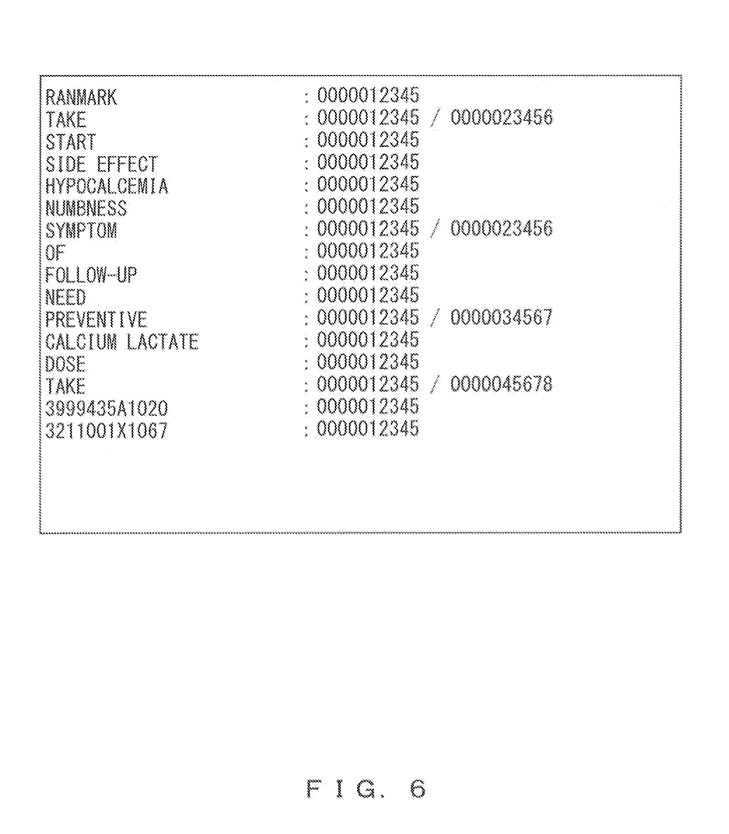

FIG. 6 illustrates a data configuration of an example of an inverted index that is index information. In the inverted index, keyword information for an index, such as “RANMARK”, that corresponds to description information of an electronic health record is associated with identification information, such as “0000012345”, of the electronic health record describing the description information that corresponds to the keyword information for an index. In the inverted index, code information for an index, such as “3999435A1020”, extracted for the keyword information for an index “RANMARK” from the user master dictionary illustrated in FIG. 2 is associated with identification information, such as “0000012345”, of an electronic health record.

As described above, in the embodiments, even when code information of a target to be retrieved such as a pharmaceutical product is not given as description information of an electronic health record, code information can be included in the index information stored in the index information storage 114 of FIG. 1, as illustrated in FIG. 6. By using the index information (inverted index) described above, the retrieval processing function unit 103 of FIG. 1 can retrieve code information in electronic health records, even when the code information is, for example, code information of a pharmaceutical product that is not given as description information of an electronic health record. This results in an increase in a probability of an electronic health record that includes the desired content being retrieved in the embodiments.

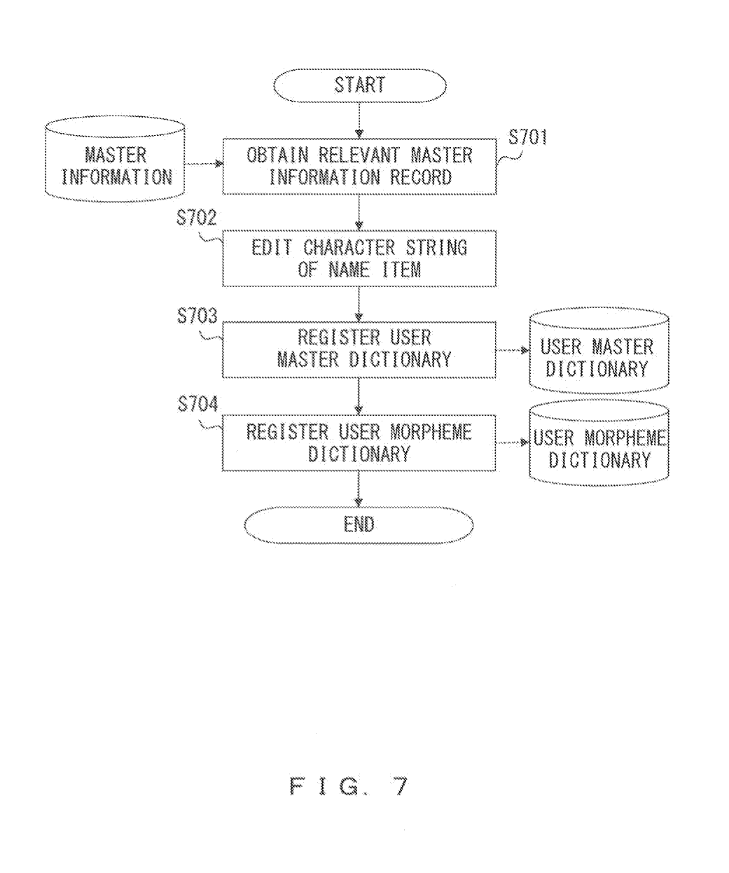

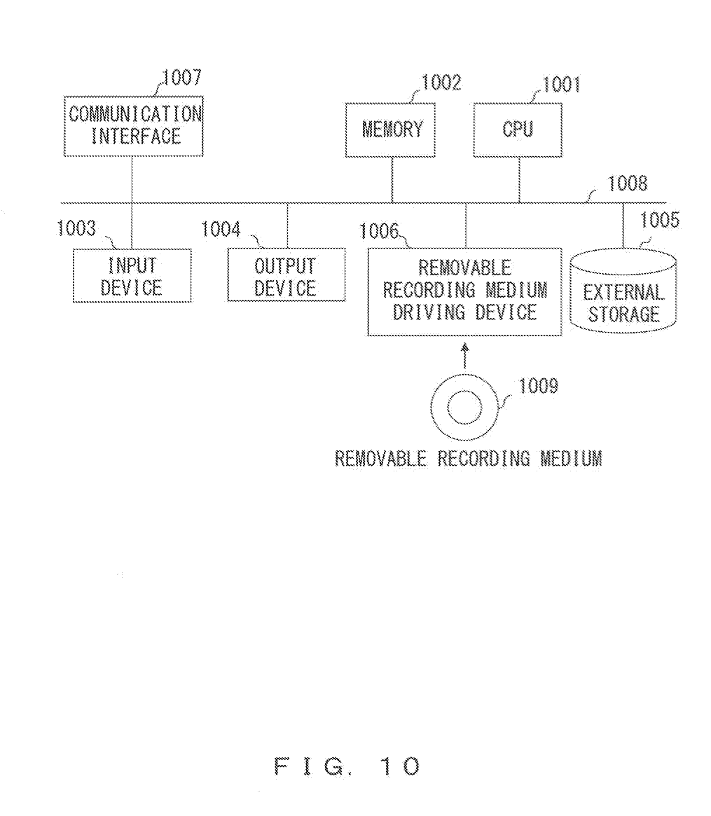

FIG. 7 is a flowchart illustrating an example of a process of generating the user master dictionary illustrated in FIG. 2 and the user morpheme dictionary illustrated in FIG. 4 on the basis of the master information illustrated in FIG. 3. This process is implemented, for example, as an action in which a Central Processing Unit (CPU) 1001 executes a control program read from an external storage 1005 to a memory 1002 in a computer having a hardware configuration of FIG. 10 described later.

First, relevant master information records are extracted, for example, from the master information “Standard Master for Pharmaceutical Products” described above (step S701) In the example of the master information illustrated in FIG. 3, the value “RANMARK Hypodermic Injection 120 mg 1.7 mL” of the item “receipt computing processing system product name”, and the corresponding value “3999435A1020” of the item “NHI drug price list code” are obtained. Further, the value “Calcium Lactate ‘KOZAKAI•M’” of the item “receipt computing processing system product name”, and the corresponding value “3211001X1067” of the item “NHI drug price list code” are obtained.

Then, a dictionary generation user that operates a computer having, for example, the hardware configuration of FIG. 10 edits a character string of a name item by using, for example, an input device 1003 and an output device 1004 such as a display (step S702). As an example, a pharmaceutical product name such as “RANMARK” or “RANMARK Hypodermic Injection” is added to the pharmaceutical product name item “RANMARK Hypodermic Injection 120 mg 1.7 mL” in each of the records obtained in step S701. As another example, a pharmaceutical product name such as “Calcium Lactate” is added to the pharmaceutical product name item of each of the records obtained in step S701, such as in “Calcium Lactate ‘KOZAKAI•M’”.

Then, a user master dictionary that is configured of a pair of master keyword information and master code information is registered in the data format illustrated in FIG. 2 (step S703). Note that FIG. 2 illustrates only a record that corresponds to the master keyword information “RANMARK”, and a record that corresponds to the master keyword information “Calcium Lactate”. In addition to these records, a record that corresponds to the master keyword information “RANMARK Hypodermic Injection 120 mg 1.7 mL” or a record that corresponds to the master keyword information “Calcium Lactate ‘KOZAKAI•M’” may be registered.

Further, a user morpheme dictionary is registered in the data format illustrated in FIG. 4 (step S704).

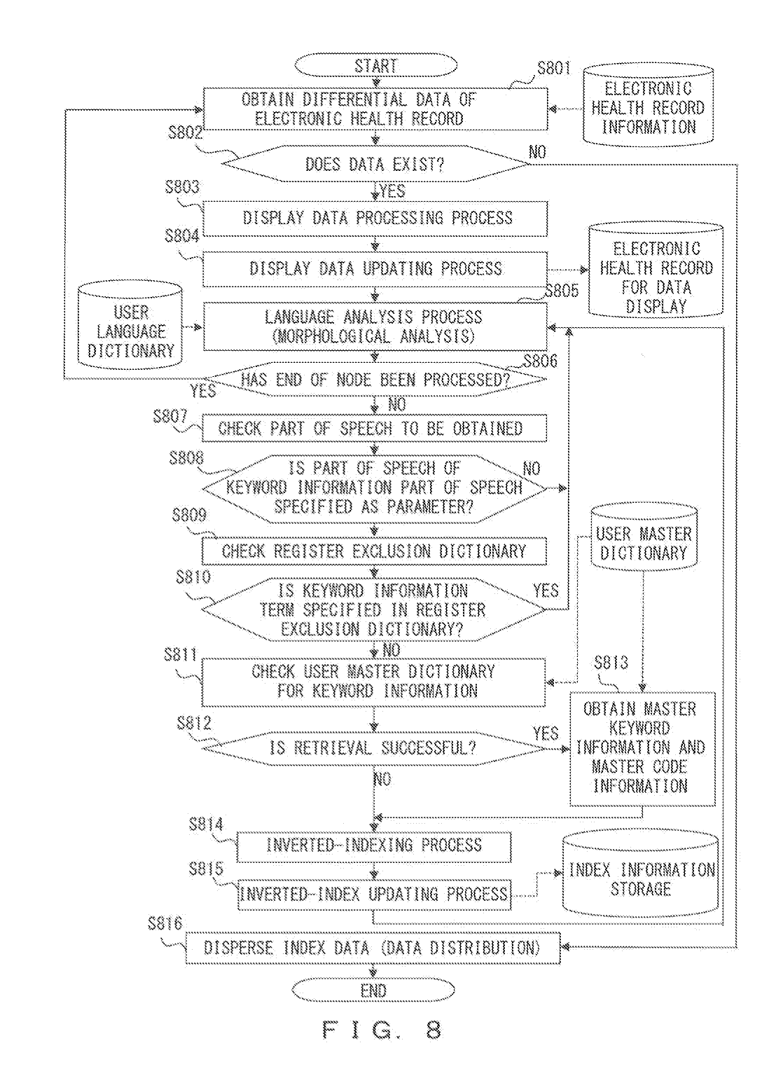

FIG. 8 is a flowchart illustrating an example of a process of generating index information performed by the index information generating function unit 102 of FIG. 1. This process is implemented, for example, as an action for executing an index information generation processing program which the CPU 1001 reads from the external storage 1005 to the memory 1002 in a computer of the electronic health record retrieval processing device 100 of FIG. 1 having a hardware configuration of FIG. 10 described later.

First, differential data of an electronic health record is obtained from the electronic health record storage 104 in the electronic health record data storage 101 of FIG. 1 (step S801). This process is, for example, a process of obtaining data of each electronic health record that is newly stored in the electronic health record storage 104 after the index information generating process is previously performed, as the differential data.

Then, it is determined whether data of an electronic health record has been obtained in step S801, and whether the data exists (step S802).

When data of an electronic health record exists, namely, when the determination result in step S802 is “YES”, the following process is performed. In order to display the electronic health record on a display of a terminal device operated by a retrieval user when the data of the electronic health record is retrieved, a process of processing display data is performed (step S803). Specifically, a process of converting a character code of description information of an electronic health record read from the electronic health record storage 104 (FIG. 1) into a character code suitable to be displayed, for example, in browser software of a terminal device is performed. Alternatively, a process of converting description information of an electronic health record into data in the HTML (Hyper Text Markup Language) form that is suitable to be displayed, for example, in the browser software of the terminal device is performed.

Then, a process of updating display data is performed (step S804). As an example, a database of an electronic health record for a data display stored in the external storage 1005 of a computer having the hardware configuration of FIG. 10 described later is updated by using the display data newly obtained in step S803 of the electronic health record.

A language analysis process is performed on description information obtained in step S801 of an electronic health record, by using a user language dictionary (step S805). As an example, morphological analysis is performed as the language analysis process, by using, as the user language dictionary, a user morpheme dictionary generated as illustrated in FIG. 4.

Then, it is determined whether the end of a node of a document of the description information obtained in step S801 of the electronic health record has been processed (step S806). The node refers to a unit of text on which a language analysis is performed, and in the embodiments, the node refers to the entirety of a document of description information of one electronic health record. Accordingly, “the end of a node” refers to the end of a sentence in a document in an electronic health record.

When the end of a node has not been processed, namely, when the determination result in step S806 is “NO”, a part of speech of keyword information that is a target obtained in step S805 is checked (step S807), and it is determined whether the part of speech of keyword information is a part of speech that has been specified as a parameter by a user (step S808). As an example, it is determined which of a noun, a verb, an adjective, and an adjective verb the part of speech of keyword information is.

When the part of speech of the keyword information obtained in step S805 is not a noun, a verb, an adjective, or an adjective verb, namely, when the determination result in step S808 is “NO”, the keyword information is not used for keyword information for an index, and the process returns to step S805.

When the part of speech is one of a noun, a verb, an adjective, or an adjective verb, namely, when the determination result in step S808 is “YES”, whether the keyword information obtained in step S805 has been specified in a register exclusion dictionary (not illustrated) is checked (step S809) and determined (step S810). The register exclusion dictionary is a dictionary in which keyword information that is not suitable for keyword information and is not suitable to be detected has been registered.

When the keyword information obtained in step S805 has been specified in the register exclusion dictionary, namely, when the determination result in step S810 is “YES”, the keyword information is not used for keyword information for an index, and the process returns to step S805.

When the keyword information obtained in step S805 has not been specified in the register exclusion dictionary, namely, when the determination result in step S810 is “NO”, a process of checking keyword information in a user master dictionary is performed (step S811). Specifically, a process in the first method above for determining keyword information for an index according to the user master dictionary is performed. Namely, a fuzzy search is performed on master keyword information in the user master dictionary illustrated in FIG. 2 by using the keyword information obtained in step S805. Then, it is determined whether retrieval is successful (step S812).

When a fuzzy search is successful, namely, when the determination result in step S812 is “YES”, master keyword information and master code information of a record that have been retrieved from the user master dictionary are obtained (step S813).

Then, an inverted-indexing process is performed (step S814). When the fuzzy search is successful, namely, when the determination result in step S812 is “YES”, the following process is performed in the inverted-indexing process. The master keyword information and the master code information obtained in step S813 are used for keyword information for an index and code information for an index. Identification information of the display data generated in step S804 of the electronic health record is associated with the keyword information for an index and the code information for an index, and an inverted index is generated in the data format illustrated in FIG. 6. When the fuzzy search is not successful, namely, when the determination result in step S812 is “NO”, the keyword information obtained in step S805 is used for keyword information for an index, identification information of the display data generated in step S804 of the electronic health record is associated with the keyword information for an index, and an inverted index is generated. In this case, an inverted index using code information for an index is not generated. An inverted index associating the identification information of the display data of the electronic health record with generation date, a diagnosis and treatment department, a patient identification information (ID), or the like of the electronic health record generated in step S804 may be generated.

Then, an inverted index stored in the index information storage 114 of FIG. 1 is updated by using the inverted index generated in step S814 (step S815). The process returns to step S805.

When the end of a node has been processed, namely, when the determination result in step S806 is “YES”, the process returns to step S801, and differential data of a subsequent electronic health record is obtained.

When no differential data of an electronic health record exists, namely, when the determination result in step S802 is “NO”, the following process is performed. In a case in which a retrieval process is dispersively performed by a plurality of computers, as described later, data of an inverted index that is index information updated in step S815 is dispersed (distributed) to the plurality of computers (step S816). Then, the index information generating process illustrated in the flowchart of FIG. 8 is terminated.

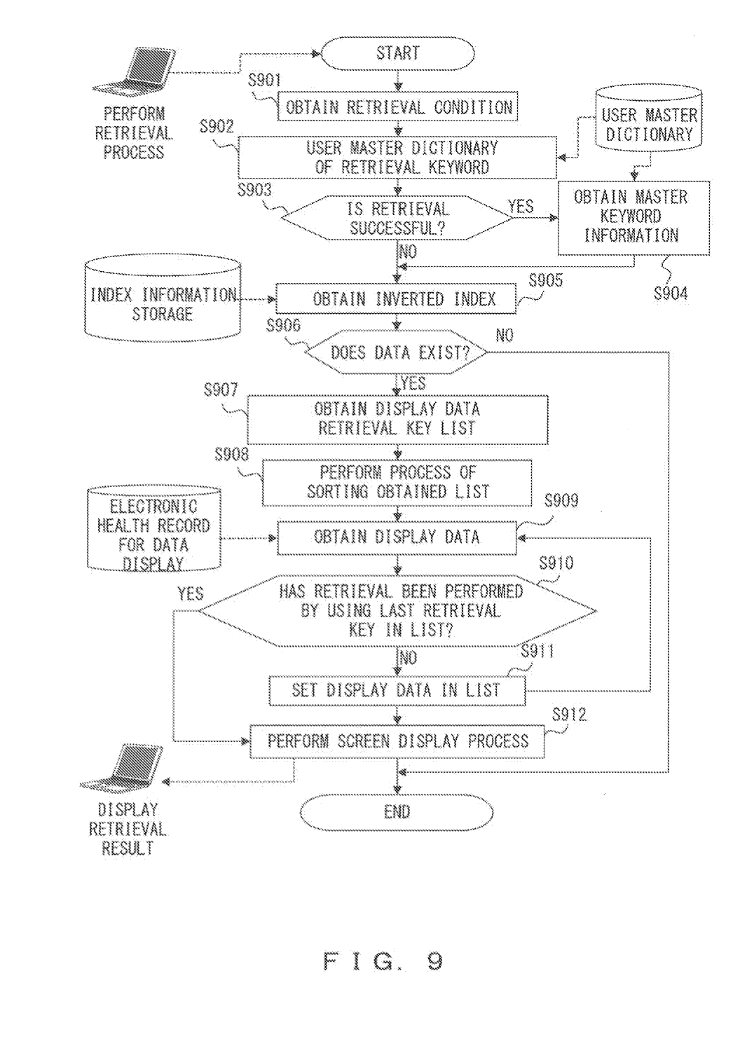

FIG. 9 is a flowchart illustrating an example of a retrieval process performed by the retrieval processing function unit 103 of FIG. 1. This process is implemented, for example, as an action in which the CPU 1001 executes a retrieval processing program read from the external storage 1005 to the memory 1002 in a computer of the electronic health record retrieval processing device 100 of FIG. 1 having the hardware configuration of FIG. 10 described later. The CPU 1001 may be, for example, a processor.

When a user who performs a retrieval process operates a terminal device so as to specify a retrieval condition, information of the retrieval condition is reported to a computer of the electronic health record retrieval processing device 100 of FIG. 1 having the hardware configuration of FIG. 10, for example, via a network. As a result, a retrieval processing program illustrated in the flowchart of FIG. 9 is started.

First, a retrieval condition is obtained (step S901) The retrieval condition includes, for example, keyword information for retrieval or code information for retrieval of the name of a pharmaceutical product. In addition, date, a diagnosis and treatment department name, a patient ID, or the like of an electronic health record may be included in the retrieval condition.

Next, a process of checking a retrieval keyword in the user master dictionary is performed (step S902). Specifically, morphological analysis in which a sentence of the retrieval condition obtained in step S901 is divided into a string of morphemes is performed. From among obtained morphemes, a morpheme that is determined to be a prescribed part of speech (for example, one of a noun, a verb, an adjective, and an adjective verb) is extracted as keyword information. From among the obtained morphemes, a morpheme that matches a format of the master code information registered in the user master information illustrated in FIG. 2 is extracted as code information. Then, the fuzzy search is performed on the master keyword information in the user master dictionary illustrated in FIG. 2 by using the keyword information above.

Then, it is determined whether retrieval is successful (step S903).

When the fuzzy search is successful, namely, when the determination result in step S903 is “YES”, master keyword information of a record that has been retrieved in the user master dictionary is obtained (step S904).

Then, an inverted index obtaining process is performed (step S905). In this process, when the fuzzy search is successful, namely, when the determination result in S904 is “YES”, the following process is performed. The master keyword information obtained in step S904 is used for keyword information for retrieval. The code information obtained in step S902 is used for code information for retrieval. Keyword information for an index or code information for an index on the inverted index illustrated in FIG. 6 that is stored in the index information storage 114 of FIG. 1 is retrieved by using the keyword information for retrieval above or the code information for retrieval above. In addition, retrieval may be performed on the inverted index by using date, a diagnosis and treatment department name, a patient ID, or the like of an electronic health record included in the retrieval condition. When the fuzzy search is not successful, namely, when the determination result in step S904 is “NO”, the following process is performed. The keyword information obtained in the morphological analysis in step S902 is used for keyword information for retrieval. Keyword information for an index on the inverted index illustrated in FIG. 6 that is stored in the index information storage 114 of FIG. 1 is retrieved by using the keyword information for retrieval. In addition, retrieval may be performed on the inverted index by using date, a diagnosis and treatment department name, a patient ID, or the like of an electronic health record included in the retrieval condition. As a result of the retrieval above, identification information of an electronic health record that corresponds to the retrieved index record is extracted from the inverted index.

It is determined whether, as a result of the retrieval in step S905, a data record of the retrieved inverted index exists, and identification information of an electronic health record has been extracted (step S906).

When no data records of the retrieved inverted index exist, namely, when the determination result in step S906 is “NO”, the retrieval process is terminated, and a retrieval result indicating no electronic health records that satisfy the retrieval condition exist is displayed in browser software of a terminal device of a user who performs the retrieval process.

When a data record of the retrieved inverted index exists, namely, when the determination result in step S906 is “YES”, a display data retrieval key list including the keyword information for retrieval above and the code information for retrieval above is obtained (step S907).

Then, a sorting process is performed on the key list obtained in step S907 (step S908).

According to the key list sorted in step S908, display data of an electronic health record is obtained from a database of data display electronic health records on the basis of the identification information extracted in step S905 of the electronic health record that corresponds to each of the retrieval keys (step S909). The database of the data display electronic health records is obtained as a result of the process of step S804 of FIG. 8 described above, and is stored, for example, in the external storage 1005 of the computer having the hardware configuration of FIG. 10 described later.

Then, it is determined whether retrieval has been performed by using the last retrieval key in the retrieval key list (step S910).

When retrieval has not yet been performed by using the last retrieval key in the retrieval key list, namely, when the determination result in step S910 is “NO”, the display data obtained in step S909 of the electronic health record is set in the retrieval key list (step S912). Then, the process returns to step S909, and a process of obtaining display data of an electronic health record that corresponds to the subsequent retrieval key is performed.

When retrieval has been performed by using the last retrieval key in the retrieval key list, namely, when the determination result in step S910 is “YES”, the retrieval key list and the display data of the electronic health record that has been set correspondingly to the retrieval key list are transmitted to the browser software of a terminal device of a user who performs the retrieval process, and displayed as a retrieval result.

As a result, the process illustrated in the flowchart of the retrieval process of FIG. 9 is terminated.

FIG. 10 illustrates an example of a hardware configuration of a computer that implements the electronic health record retrieval processing device 100 of FIG. 1 as software processing.

A computer illustrated in FIG. 10 includes a CPU 1001, a memory 1002, an input device 1003, an output device 1004, an external storage 1005, a removable recording medium driving device 1006 into which a removable recording medium 1009 is inserted, and a communication interface 1007, and the computer illustrated in FIG. 10 is configured that these components are connected to each other via a bus 1008. The configuration illustrated in FIG. 10 is an exemplary configuration of a computer that can implement the system above, and the configuration of such a computer is not limited to this configuration.

The CPU 1001 controls the entirety of the computer. The memory 1002 is a memory such as a RAM that temporarily stores a program or data stored in the external storage 1005 (or the removable recording medium 1009) when the program is executed or the data is updated. The CPU 1001 reads a program into the memory 1002, and executes the program so as to control the entirety of the computer.

The input device 1003 detects an input operation of a user via a keyboard, a mouse, or the like, reports a detection result to the CPU 1001, and outputs data transmitted under the control of the CPU 1001 to a display or a printer.

The external storage 1005 is, for example, a hard disk storage. The external storage 1005 is, for example, used to store various pieces of data or programs.

The removable recording medium driving device 1006 houses the removable recording medium 1009 such as an optical disk, an SDRAM, or a compact flash, and has a function to assist the external storage 1005.

The communication interface 1007 is a device that connects a communication line of, for example, a LAN (Local Area Network) or a WAN (Wide Area Network).

The electronic health record retrieval processing device 100 according to the embodiments is implemented by executing, by the CPU 1001, a program implementing respective functions of the index information generating function unit 102 or the retrieval processing function unit 103 of FIG. 1 that are implemented, for example, in the flowchart of FIG. 7, 8, or 9. The program may be recorded and distributed, for example, in the external storage 1005 or the removable recording medium 1009, or may be obtained from a network via the network connecting device 1007.

In order to perform efficient information retrieval on a large-scale electronic health record database, the embodiments may be realized by using, for example, the following technology developed by the Apache Software Foundation, which is an American non-profit corporation.

A Java (a registered trademark of Oracle Corporation) framework, called “Hadoop”, for distributed processing of large-scale data may be used. This framework is an open-source platform that enables a large amount of data such as electronic health records to be dispersively processed by a plurality of computers. In this case, the index information generating function unit 102 and the retrieval processing function unit 103 of FIG. 1 are constructed according to Hadoop, and functions of the index information generating function unit 102 and the retrieval processing function unit 103 are dispersively executed on a plurality of computers.

A column-oriented distributed database, called “Hbase”, that is executed on a distributed file system “HDFS” of Hadoop may be used. In this case, a database of the electronic health record storage 104 of FIG. 1 is dispersively processed by a plurality of computers of the electronic health record data storages 101.

Further, Java full-text search engine software called “Lucene”, or a full-text search web application system based on Lucene, called “Solr”, that includes a management screen that enables web access and a cache mechanism may be used. In this case, the retrieval processing function unit 103 of FIG. 1 is constructed according to Lucene or Solr.

In the embodiments described above, index information that is an inverted index stores keyword information for an index and code information for an index in association with identification information that corresponds to an electronic health record having respective pieces of description information that correspond to the keyword information for an index and the code information for an index. In addition, the inverted index may store keyword information extracted from the description information that corresponds to the above keyword information for an index in the description information of the electronic health record, and information relating to a description position at which the above code information for an index is located, in association with each other. By using the inverted index described above, not only the description information of all of the retrieved electronic health records but also a description position that corresponds to a keyword or the like of a retrieval condition in the description information can be displayed as a retrieval result.

In the embodiments above, a case has been described in which a target is, for example, a pharmaceutical product, keyword information of the target is, for example, a pharmaceutical product name, and code information that identifies the target is, for example, code information that identifies the pharmaceutical product. The target may be, for example, a disease or an operation, the keyword information of the target may be, for example, the name of a disease or the name of an operation, and the code information that identifies the target may be, for example, code information that identifies the name of a disease or the name of an operation.

A language used for the description information of an electronic health record is not limited to Japanese, and may be various foreign languages such as English, German, or French.

According to the embodiments above, an electronic health record can be retrieved even by using code information of a target to be retrieved that is not given as description information of an electronic health record.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
reading an electronic health record from an electronic health record storage that stores identification information that identifies the electronic health record and description information given in the electronic health record in association with each other;
determining keyword information that corresponds to the description information given in the read electronic health record in accordance with a master storage that stores keyword information of a target and code information that identifies the target in association with each other;
reading the code information that corresponds to the determined keyword information from the master storage; and
generating index information that corresponds to the read electronic health record by associating the identification information that corresponds to the read electronic health record with each of the determined keyword information and the read code information.

2. The non-transitory computer-readable recording medium according to claim 1, wherein
the determining the keyword information and the reading the code information include:
extracting the keyword information from the description information given in the read electronic health record;
performing a fuzzy search on master keyword information stored in the master storage by using the keyword information extracted from the description information;
when the fuzzy search is successful, using the keyword information and the code information retrieved from the master storage for the determined keyword information and the read code information; and
when the fuzzy search is not successful, determining the keyword information extracted from the description information to be the keyword information, and not reading the code information.

3. The non-transitory computer-readable recording medium according to claim 2, wherein
the extracting the keyword information from the description information given in the read electronic health record includes:
performing morphological analysis in which a sentence of the description information given in the read electronic health record is divided into a string of morphemes; and
extracting, as the keyword information, a morpheme that is determined to be a prescribed part of speech from among the morphemes.

4. The non-transitory computer-readable recording medium according to claim 1, the process further comprising:
registering respective pieces of keyword information in the master storage in a user dictionary for the morphological analysis, wherein
the determining the keyword information includes:
performing morphological analysis in which a sentence of the description information given in the read electronic health record is divided into a string of morphemes; and
determining, as the keyword information, a morpheme that is determined to be a prescribed part of speech from among the morphemes.

5. The non-transitory computer-readable recording medium according to claim 2, wherein
the index information is inverted index information that associates information relating to a description position at which the keyword information extracted from the description information that corresponds to the determined keyword information is located within the description information of the electronic health record, in addition to the identification information that corresponds to the read electronic health record, with each of the determined keyword information and the read code information.

6. The non-transitory computer-readable recording medium according to claim 1, wherein
the target is a pharmaceutical product,
the keyword information of the target is a name of the pharmaceutical product, and
the code information that identifies the target is code information that identifies the pharmaceutical product.

7. The non-transitory computer-readable recording medium according to claim 1,
inputting a retrieval condition;
determining keyword information for retrieval or code information for retrieval that corresponds to the input retrieval condition;
retrieving keyword information or code information that corresponds to the keyword information for retrieval or the code information for retrieval from index information, and extracting corresponding identification information; and
reading, from an electronic health record storage, description information of the electronic health record that corresponds to the extracted identification information, and displaying the description information.

8. The non-transitory computer-readable recording medium according to claim 7, the process further comprising:
determining the keyword information for retrieval or the code information for retrieval that corresponds to the input retrieval condition according to a master storage.

9. The non-transitory computer-readable recording medium according to claim 8, wherein
the determining the keyword information for retrieval includes:
extracting the keyword information or the code information from the retrieval condition;
determining the code information extracted from the retrieval condition to be the code information for retrieval;
performing a fuzzy search on keyword information stored in the master storage by using the keyword information extracted from the retrieval condition;
when the fuzzy search is successful, determining the keyword information retrieved in the master storage to be the keyword information for retrieval; and
when the fuzzy search is not successful, determining the keyword information extracted from the retrieval condition to be the keyword information for the retrieval.

10. The non-transitory computer-readable recording medium according to claim 9, wherein
the extracting the keyword information or the code information from the retrieval condition includes:
performing morphological analysis in which a sentence of the retrieval condition is divided into a string of morphemes;
extracting, as the keyword information, a morpheme that is determined to be a prescribed part of speech from among the morphemes; and
extracting, as the code information, a morpheme that matches a format of the code information in the master storage from among the morphemes.

11. The non-transitory computer-readable recording medium according to claim 10, wherein
in the morphological analysis of the sentence of the retrieval condition, respective pieces of keyword information in the master storage are registered in a user dictionary for the morphological analysis in such a way that the respective pieces of keyword information in the master storage are divided as the morphemes.

12. The non-transitory computer-readable recording medium according to claim 7, the process further comprising:
extracting, from the index information, information relating to a description position at which the keyword information or the code information extracted from the retrieval condition that corresponds to the keyword information for retrieval or the code information for retrieval is located within the description information of the electronic health record that corresponds to the identification information, in addition to the identification information that corresponds to the keyword information or the code information retrieved from the index information; and
reading, from the electronic health record storage, the description information of the electronic health record that corresponds to the extracted identification information, and displaying the description information in addition to the information relating to the description position.

13. An information retrieval processing device comprising:
a processor that executes a process including:
reading an electronic health record from an electronic health record storage that stores identification information that identifies the electronic health record and description information given in the electronic health record in association with each other;
determining keyword information that corresponds to the description information given in the read electronic health record in accordance with a master storage that stores keyword information of a target and code information that identifies the target in association with each other;
reading the code information that corresponds to the determined keyword information from the master storage; and
generating index information that corresponds to the read electronic health record by associating the identification information that corresponds to the read electronic health record with each of the determined keyword information and the read code information.

14. The information retrieval processing device according to claim 13, wherein
the processor further performs a process including:
inputting a retrieval condition;
determining keyword information for retrieval or code information for retrieval that corresponds to the input retrieval condition according to the master storage;
retrieving keyword information or code information that corresponds to the keyword information for retrieval or the code information for retrieval from the index information, and extracting corresponding identification information; and
reading, from the electronic health record storage, the description information of the electronic health record that corresponds to the extracted identification information, and displaying the description information.

15. An information retrieval processing method comprising:
reading an electronic health record from an electronic health record storage that stores identification information that identifies the electronic health record and description information given in the electronic health record in association with each other;
determining keyword information that corresponds to the description information given in the read electronic health record in accordance with a master storage that stores keyword information of a target and code information that identifies the target in association with each other;
reading the code information that corresponds to the determined keyword information from the master storage; and
generating, by a processor, index information that corresponds to the read electronic health record by associating the identification information that corresponds to the read electronic health record with each of the determined keyword information and the read code information.

16. The information retrieval processing method according to claim 15, further comprising:
inputting, by the processor, a retrieval condition;
determining, by the processor, keyword information for retrieval or code information for retrieval that corresponds to the input retrieval condition in accordance with the master storage;
retrieving, by the processor, keyword information or code information that corresponds to the keyword information for retrieval or the code information for retrieval from the index information, and extracting corresponding identification information; and
reading, by the processor, from the electronic health record storage, the description information of the electronic health record that corresponds to the extracted identification information, and displaying the description information.
